(19) United States
(12) Patent Application Publication
(10) Pub. No.: US 2006/0109121 A1
(43) Pub. Date: May 25, 2006

(54) RFID embedded in device

(76) Inventors: Terry J. Dishongh, Portland, OR (US); Tom E. Pearson, Beaverton, OR (US); Dudi I. Amir, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/993,895

(22) Filed: Nov. 19, 2004

(51) Int. Cl. G08B 13/14

(52) U.S. Cl. 340/572.1

(57) ABSTRACT

A radio frequency identification (RFID) device may incorporate an existing feature on a substrate as an antenna. In some embodiments, the electromagnetic interference (EMI) guard ring on a substrate may form the antenna for the RFID device.

### BACKGROUND

The assembly of many products typically involves finding, identifying, and tracking various parts by individual identifying information, such as part numbers, serial numbers, lot numbers, revision levels, date codes, etc. Rework, removal, or inventory control may also require that the individual parts of the finished product be identified. Conventional techniques for identifying parts may depend on visual techniques, such as manually reading part numbers or automatically scanning bar codes, techniques that may be time consuming, may require disassembling the product or opening a box containing the product, and/or may require human labor to perform the identification. Other techniques may use radio frequency identification (RFID) devices attached to the parts to electronically read identification information from the parts, but RFID devices are generally too large to be feasible on relatively small substrates, and the attachment process may add to manufacturing costs. The problem, at least in part, may be due to the antenna that comes with the RFID device, and the fact that the RFID device and its antenna are separate structures that must be added to the device to be identified.

### BRIEF DESCRIPTION OF THE DRAWINGS

The invention may be understood by referring to the following description and accompanying drawings that are used to illustrate embodiments of the invention. In the drawings:

FIG. 1 shows an embodiment of a PC board with an RFID device that uses a guard ring on the PC board for an antenna, according to an embodiment of the invention.

FIG. 2 shows a device comprising multiple PC boards of a type such as the PC board exemplified in FIG. 1, according to an embodiment of the invention.

FIG. 3 shows a system in which one or more devices incorporating RFID elements described herein are read by an RFID reader, according to an embodiment of the invention.

FIG. 4 shows an embodiment of an integrated circuit with an RFID device that uses a guard ring on the integrated circuit for an antenna, according to an embodiment of the invention.

FIG. 5 shows a flow chart of a method of operating a substrate with an RFID device using a feature of the substrate as an antenna for the RFID device, according to an embodiment of the invention.

### DETAILED DESCRIPTION OF THE INVENTION

In the following description, numerous specific details are set forth. However, it is understood that embodiments of the invention may be practiced without these specific details. In other instances, well-known circuits, structures and techniques have not been shown in detail in order not to obscure an understanding of this description.

References to “one embodiment”, “an embodiment”, “example embodiment”, “various embodiments”, etc., indicate that the embodiment(s) of the invention so described may include a particular feature, structure, or characteristic, but not every embodiment necessarily includes the particular feature, structure, or characteristic. Further, repeated use of the phrase “in one embodiment” does not necessarily refer to the same embodiment, although it may.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

The term “processor” may refer to any device or portion of a device that processes electronic data from registers and/or memory to transform that electronic data into other electronic data that may be stored in registers and/or memory. A “computing platform” may comprise one or more processors.

As used herein, unless otherwise specified the use of the ordinal adjectives “first”, “second”, “third”, etc. , to describe a common object, merely indicate that different instances of like objects are being referred to, and are not intended to imply that the objects so described must be in a given sequence, either temporally, spatially, in ranking, or in any other manner.

Embodiments of the present invention may include apparatuses for performing the operations herein. An apparatus may be specially constructed for the desired purposes, or it may comprise a general purpose device selectively activated or reconfigured by a program stored in the device.

The invention may be implemented in one or a combination of hardware, firmware, and software. The invention may also be implemented as instructions stored on a machine-readable medium, which may be read and executed by a processing platform to perform the operations described herein. A machine-readable medium may include any mechanism for storing, transmitting, or receiving information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, the interfaces that transmit and/or receive those signals, etc.), and others.

The term ‘substrate’, as used herein, may refer to a generally planar material (which might be either rigid or flexible) on which electronic circuitry is either attached (e.g., as by attaching integrated circuits to a substrate in the form of a printed circuit board) or constructed (e.g., as by fabricating electronic circuitry on a substrate in the form of a wafer or die), or equivalents thereof. Examples of substrates may also include devices that are intermediate between a PC board and an integrated circuit.

The term radio frequency identification, or its acronym ‘RFID’, may be used herein to describe devices in which the energy obtained from a received radio signal is used to power circuitry that transmits identification information. However, the various embodiments of the invention may encompass devices described with labels other than RFID.

Various embodiments of the invention may comprise a radio frequency identification (RFID) device on a substrate, using a component of the substrate as an RFID antenna, the component also providing some functional capability to the circuitry on the substrate unrelated to the RFID device, i.e., capability that would be useful even if the RFID device were not present. In some embodiments, the component may comprise a guard ring that serves as an electromagnetic interference (EMI) element for other circuitry on the substrate. An EMI element may help shield circuitry on the substrate from incoming electromagnetic radiation that might interfere with correct operation of the circuitry, and/or reduce unwanted outgoing emissions of electromagnetic radiation from the substrate.

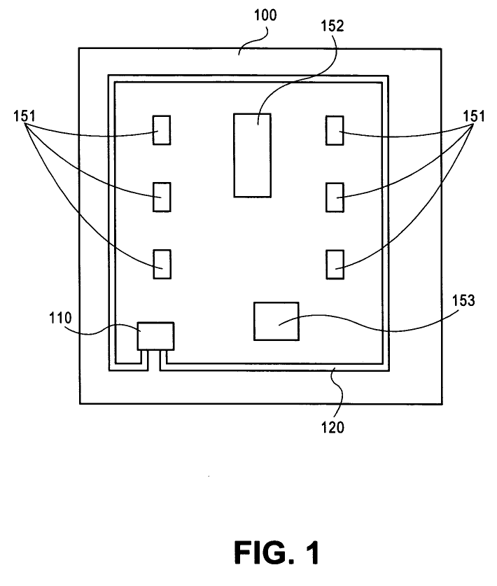

FIG. 1 shows an embodiment of a PC board with an RFID device that uses a guard ring on the PC board for an antenna, according to an embodiment of the invention. In the illustrated embodiment, PC board 100 may have a number of components 151, 152, 153, such as integrated circuits and/or other types of active and passive electronic components, mounted on the PC board.

There may also be a guard ring 120 disposed on the PC board 100. In some embodiments the guard ring 120 may be an electrically conductive trace on or below the surface of the PC board, the guard ring 120 substantially surrounding the area populated with the components 151-153. The guard ring 120 may serve as an EMI component to protect the components 151-153 on the PC board 100 from interference by incoming electromagnetic signals. The incoming electromagnetic signals may be deliberated transmitted signals from another device, and/or may be inadvertently transmitted from another device. Although the illustrated guard ring forms approximately one full loop, other embodiments may form less than or more than one loop, including multiple loops.

RFID device 110 may be electrically coupled to the guard ring 120 to use the guard ring as an antenna. In some embodiments the dimensions of the guard ring and the frequency used by the RFID device 100 may be ‘tuned’ to one another to improve the detectability of signals transmitted from and/or received by the antenna. Such tuning may be done by designing the guard ring to suit the frequency of the RFID device, and/or by using an RFID device whose frequency suits the dimensions of the guard ring. In some embodiments the guard ring may be electrically isolated from other circuitry on the substrate (other than the antenna connections to the RFID device 110), but other embodiments may use other techniques (e.g., the guard ring may be coupled to electrical ground or other power plane through a passive resistance element such as a resistor or an active resistance element such as a diode or transistor, etc.).

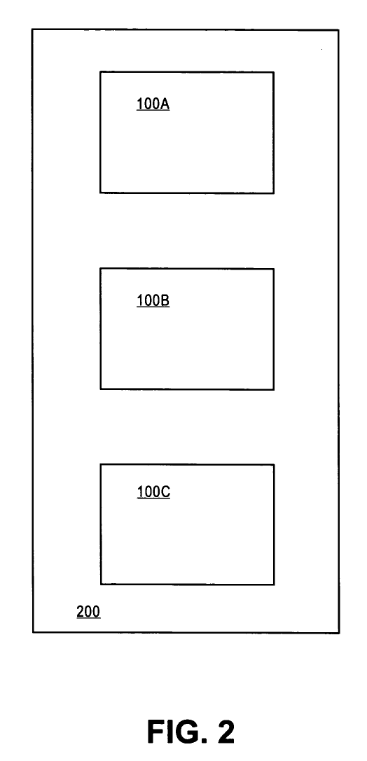

FIG. 2 shows a device comprising multiple PC boards of a type such as the PC board exemplified in FIG. 1, according to an embodiment of the invention. In the illustrated embodiment, electronic device 200 comprises PC boards 100A, 100B, 100C, although in other embodiments device 200 may comprise a quantity of PC boards other than the three shown. In some embodiments device 200 may be an electronic device, such as but not limited to, a personal computer, an audio device, a video device, a camera, a radar system, etc., in which the PC boards may electronically cooperate with one another to perform the intended operations of device 200. In other embodiments device 200 may be a container housing multiple PC boards for storage and/or shipping. In other embodiments device 200 may serve other purposes.

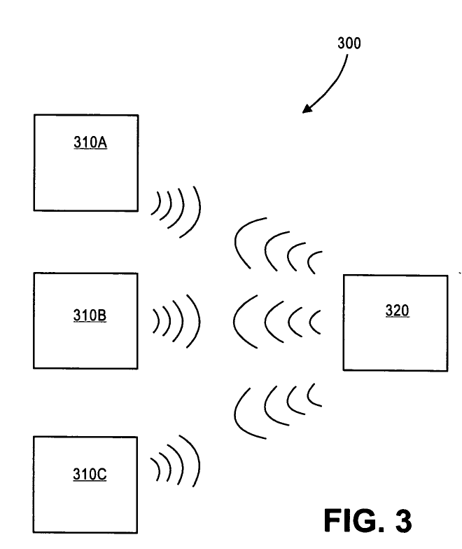

FIG. 3 shows a system in which one or more devices incorporating RFID elements described herein are read by an RFID reader, according to an embodiment of the invention. The illustrated system shows three devices 310A, B, C, being read concurrently, but other embodiments may have more or fewer than three such devices. In some embodiments of the illustrated system 300, devices 310A, 310B, 310C may be printed circuit boards such as printed circuit boards 100A, 100B, 100C shown in FIG. 2. In other embodiments, each of devices 310A-C may be similar to device 200 shown in FIG. 2. In still other embodiments, each of devices 310 A-C may be other devices not specifically listed.

In operation, RFID reader 320 may transmit a signal (such as but not limited to a low frequency signal). The energy from this signal that is received by each RFID device may be used to power a transmit circuit in each RFID device, causing such RFID device to transmit a signal (such as but not limited to a high frequency signal) containing a code that identifies that particular RFID device. The code from each RFID device may be received by RFID reader 320. The codes received by RFID reader 320 may then be compared with a database of codes to determine which specific components, PC boards, integrated circuits, etc. are present in the immediate area of the RFID reader 320. Such comparison may be performed immediately, or the codes may be stored and the comparison performed at a later time. In some embodiments the RFID devices 310A-C may repeatedly transmit as long as the reader 320 continues to supply them with sufficient transmitted energy. Each device 310A-C may have to wait between each of its transmissions to store up enough received energy for its next transmission, a time period that may vary within each RFID device with the amount of energy being received, and may vary from one RFID device to another with the transmission energy needed by that particular RFID device. Although interference between devices that transmit simultaneously may occur, the repeated transmissions by each device, and the irregular and unsynchronized nature of the retransmissions from different devices, may allow each device to transmit its code without interference at least once during the time the RFID reader is within range. Such concurrent (as opposed to simultaneous) transmissions may allow multiple devices in close proximity to be read by RFID reader 320, even if more than one of such devices transmit at the same frequency.

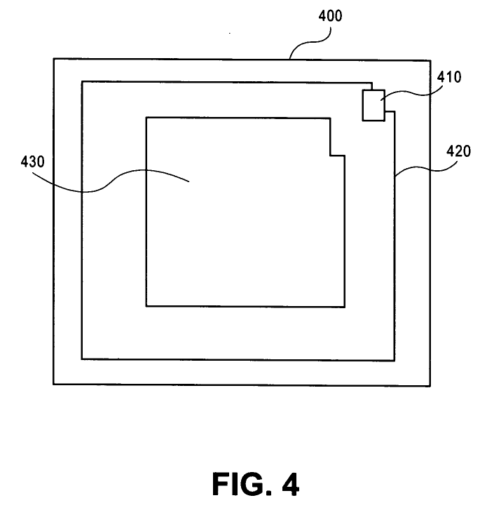

FIG. 4 shows an embodiment of an integrated circuit with an RFID device that uses a guard ring on the integrated circuit die for an antenna, according to an embodiment of the invention. In the illustrated embodiment, integrated circuit 400 comprises a circuit area 430 containing circuitry for various purposes, such as but not limited to a microprocessor, input-output circuit, graphics accelerator, memory, etc. Integrated circuit 400 may also comprise an RFID device 410 disposed on the integrated circuit die, electrically connected to a ring 430 disposed between the circuit area 430 and the periphery of the integrated circuit die. The ring 430 may serve as an antenna for the RFID device, and may also serve as an ESD guard ring, as previously described for a PC board, or other purpose in addition to serving as an antenna for the RFID device. In some embodiments, the substrate on which the circuitry, RFID device, and antenna/guard ring are disposed may be a substrate on which an integrated circuit is mounted, and that substrate may in turn be attached to a printed circuit board. Regardless of the size or assembly level of the substrate, in some embodiments the antenna/guard ring may be disposed substantially around the circuitry protected by the guard ring, and may be at or near the periphery of the substrate. In some embodiments multiple integrated circuits 400 may be combined in a device in a similar manner as the multiple PC boards 100A-C described in FIG. 2, and may be concurrently read by an RFID reader as described for FIG. 3.

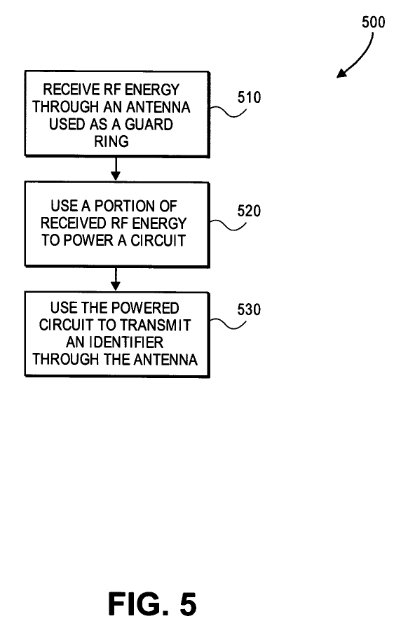

FIG. 5 shows a flow chart of a method of operating a substrate with an RFID device using a feature of the substrate as an antenna for the RFID device, according to an embodiment of the invention. In flow chart 500, the method may start at 510 with an RFID device receiving radio frequency (RF) energy through an antenna that may also be used for other purposes (for example, the feature that forms the antenna may also be used as an EMI guard ring for circuitry other than the RFID device, although various embodiments of the invention may not be limited to this specific type of alternate use). At 520 the received RF energy may be used to power the RFID device. In some embodiments, the energy may be accumulated until enough energy is available to power the RFID device. At 530 the powered RFID device may then transmit an identifier, using a portion of that accumulated energy. The device identified by the identifier may be any feasible device, such as but not limited to: a PC board, an integrated circuit, a substrate other than a PC board on which an integrated circuit is mounted, etc. The device being identified may contain digital components, analog components, or both.

The foregoing description is intended to be illustrative and not limiting. Variations will occur to those of skill in the art. Those variations are intended to be included in the various embodiments of the invention, which are limited only by the spirit and scope of the appended claims.

What is claimed is:

1. An apparatus, comprising:
a substrate;
electronic circuitry disposed on the substrate;
a radio frequency identification (RFID) device disposed on the substrate; and
a conductive element disposed on the substrate and coupled to the RFID device, the conductive element to be used as an antenna by the RFID device;
wherein the conductive element is also to perform a particular electronic operation associated with the electronic circuitry, the particular electronic operation not directly associated with operation of the RFID device.

2. The apparatus of claim 1, wherein the substrate is a printed circuit board.

3. The apparatus of claim 1, wherein the substrate is an integrated circuit die.

4. The apparatus of claim 1, wherein the antenna is operable as a guard ring.

5. The apparatus of claim 4, wherein the guard ring is to provide electromagnetic interference protection.

6. The apparatus of claim 1, wherein the antenna is disposed between a periphery of the substrate and the electronic circuitry.

7. A method, comprising:
receiving a radio frequency signal through an antenna; and
transmitting an identification signal through the antenna, energy for said transmitting being derived from energy received by said receiving;
wherein the antenna is also operable as at least part of an electromagnetic interference (EMI) protection element.

8. The method of claim 7, wherein said receiving and said transmitting are performed on a printed circuit board and the EMI protection element is to protect circuitry on the printed circuit board from interference by electromagnetic radiation.

9. The method of claim 7, wherein said receiving and said transmitting are performed on a single integrated circuit and the EMI protection element is to protect circuitry on the single integrated circuit from interference by electromagnetic radiation.

10. The method of claim 7, wherein said transmitting and said receiving are performed by an RFID device disposed on a substrate comprising the antenna.

11. A system, comprising
an electronic device comprising a plurality of substrates,
a radio frequency identification (RFID) device disposed on at least one of the substrates; and
an antenna disposed on said at least one of the substrates and coupled to the RFID device for receiving and transmitting radio signals by the RFID device, the antenna being operable to perform an electronic operation associated with circuitry on said at least one of the substrates, the electronic operation not directly associated with operation of the RFID device.

12. The system of claim 11, wherein said at least one of the substrates comprises a printed circuit board.

13. The system of claim 11, wherein said at least one of the substrates is an integrated circuit.

14. The system of claim 11, wherein the antenna comprises a conductive trace useable both as an antenna by the RFID device and as a guard ring by the circuitry.

15. The system of claim 14, wherein the conductive trace is disposed substantially between the circuitry and a periphery of the substrate.
